(19) United States
(12) Patent Application Publication
(10) Pub. No.: US 2008/0035480 A1
(43) Pub. Date: Feb. 14, 2008

(54) Sensor Element For Determining The Physical Property Of A Test Gas

(76) Inventors: Berndt Cramer, Leonberg (DE); Bernd Schumann, Rutesheim (DE); Rolf Speicher, Tuebingen (DE); Ralf Liedtke, Stuttgart (DE)

Correspondence Address: KENYON & KENYON LLP, ONE BROADWAY, NEW YORK, NY, 10004, US

(21) Appl. No.: 10/593,020

(22) PCT Filed: Mar. 2, 2005
(86) PCT No.: PCT/EP05/50916

§ 371 Date: May 14, 2007

(30) Foreign Application Priority Data
Mar. 20, 2004 (DE) 102004013852.4

(51) Int. Cl. G01N 27/26

(52) U.S. Cl. 204/424

(57) ABSTRACT

A sensor element for determining a physical property of a test gas, e.g., the concentration of a gas component in a gas mixture, in particular the oxygen concentration in the exhaust gas from internal combustion engines, has a solid electrolyte body, an external electrode exposed to the test gas situated on the solid electrolyte body, an internal electrode situated in the solid electrolyte body, and an electrical resistance heater which has a meandering heating surface situated in the solid electrolyte body, and is embedded in insulation. The external electrode is situated in a cavity formed in the solid electrolyte body to reduce the heat losses from the sensor element due to convection and radiation to the cold test gas flow.

### FIELD OF THE INVENTION

The present invention relates to a sensor element for determining the physical property of a test gas, in particular the concentration of a gas component in a gas mixture, e.g., the oxygen concentration in the exhaust gas from internal combustion engines.

### BACKGROUND INFORMATION

A conventional sensor element for a wideband lambda sensor used to determine the oxygen concentration in the exhaust gas of internal combustion engines or combustion engines, e.g., as described in published German patent document DE 199 41 051, has a plurality of layers or films made from an oxygen ion-conductive solid electrolyte material, e.g., zirconium oxide (ZrO₂) fully or partially stabilized using yttrium oxide, which is laminated to form a planar, ceramic body and subsequently sintered. A test gas chamber and a reference gas channel are formed in the layer or film laminate, and an electrical resistance heater provided with an insulating jacket is embedded in it. A reference gas, e.g., air, is admitted to the reference gas channel and exhaust gas is admitted to the test gas chamber via a diffusion barrier. The sensor element has a pump cell for pumping oxygen into or out of the test gas chamber and a Nernst cell or concentration cell for measuring the oxygen concentration. The pump cell has an external and an internal pump electrode; the Nernst or concentration cell has a Nernst or test electrode and a reference electrode. The reference electrode is situated in the reference gas channel on the solid electrolyte. The internal pump electrode and the Nernst or test electrode are placed in the test gas chamber and are positioned diametrically opposite from one another on one of the solid electrolyte layers. The external pump electrode is situated on the outside of the solid electrolyte layer carrying the internal pump electrode facing away from the internal pump electrode and is preferably exposed to the exhaust gas via a porous protective layer. The electrical resistance heater heats the sensor to the necessary operating temperature of approximately 750° C. to 800° C. The voltage that can be applied to the electrical resistance heater for this purpose is limited by the vehicle system voltage.

In a cold start, the resistance heater requires a certain amount of time until it has heated the sensor to the operating temperature and the sensor is able to supply a reliable measured value of the oxygen concentration in the exhaust gas. However, the sensor is unable to measure the oxygen concentration during the heating process, so it is not possible to optimally adjust the fuel mixture of the internal combustion engine, and high exhaust emissions occur. In addition, heat losses caused by cooling of the sensor by the cold exhaust gas and heat dissipation extend the heating time of the sensor.

In a conventional sensor element for a linear air-fuel sensor operating according to the limiting current principle for determining at least one gas component of an exhaust gas of a combustion engine, it being possible to heat the sensor element to the operating temperature by an integrated electrical resistance heater, e.g., as described in published German patent document DE 191 14 186, a thermally conductive layer of platinum being applied to at least one outer surface of the sensor element, specifically in such areas of the outer surface having a high temperature gradient due to the heating by the resistance heater and due to the temperature distribution present outside of the sensor element during operation. The thermally conductive layer balances temperatures between areas having different temperatures, resulting in a reduction of the temperature gradient and accordingly the mechanical stresses in the sensor element which can lead to cracks. The thermally conductive layer contains a metal, platinum in particular, and has a thickness of 5 μm to 50 μm. A ceramic material, e.g., aluminum oxide (Al₂O₃), is added for stabilization.

### SUMMARY

The sensor element according to the present invention has the advantage that “burying” the external electrode at the bottom of the cavity significantly reduces the thermal losses of the sensor element. The cavity conducts so little of the thermal energy that an advantageous thermal insulation is achieved. Furthermore, the external electrode, e.g., made of platinum, now forms an internal boundary surface and, due to its low emissivity in relation to the zirconium oxide of the solid electrolyte, significantly less energy is given off through radiation. Overall, the heating time of the sensor element until it reaches its operating temperature is shortened, and the convective heat loss due to a strong, cold test gas flow is reduced during operation of the sensor element, and the need for heat output is accordingly reduced.

According to an example embodiment of the present invention, the solid electrolyte body has a second cavity which is situated in the solid electrolyte body close to the outside of the solid electrolyte body facing away from the first cavity and extends over the area of the heating surface of the resistance heater. The second cavity may be incorporated from the outside, is open to the outside and is closed by a second cover. Also in this case, the cavity, as a poor thermal conductor, protects the interior of the sensor element from a loss of energy.

According to an example embodiment of the present invention, the bottom of the second cavity opposite the cover is provided with a coating having low emissivity which is made, for example, from platinum or ruthenium oxide or other noble metals and their oxides. This coating also results in a boundary surface having a low emissivity coefficient, and accordingly low radiation losses, and acts as a reflector that reflects the thermal radiation back to the internal sensor areas.

According to an example embodiment of the present invention, the two cavities are filled with a porous material, e.g., a highly porous ceramic, having thermal insulating properties very similar to those of the cavity but higher mechanical stability.

If it is intended to achieve a higher stability without cavity filling, another example embodiment of the invention provides braces integrated into the cavities to brace the covers against the bottom of the cavities.

According to an example embodiment of the present invention, the covers are manufactured from a material having a higher mechanical coefficient of expansion than the solid electrolyte. This causes mechanical stresses developing due to the different temperatures at the covers and the solid electrolyte to be minimized, in particular when both have the same coefficient of expansion.

### BRIEF DESCRIPTION OF THE DRAWINGS

FIG. 1 shows a longitudinal section of a sensor element for a wideband lambda sensor.

FIG. 2 shows a section taken along line II-II shown in FIG. 1.

FIGS. 3 and 4 each show a longitudinal section to FIG. 1 of a sensor element for a wideband lambda sensor according to two additional exemplary embodiments.

FIG. 5 shows a sectional view corresponding to the section shown in FIG. 2, of a wideband lambda sensor according to another exemplary embodiment.

### DETAILED DESCRIPTION

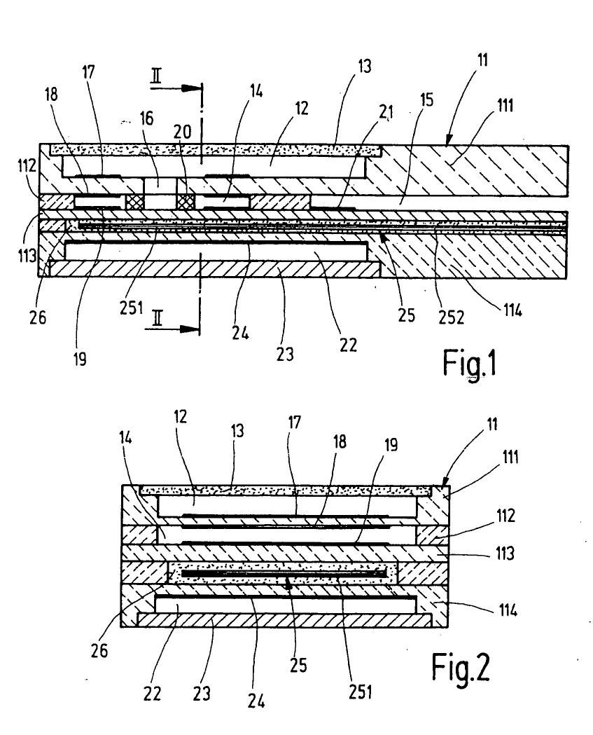

The sensor element shown in different sectional views in FIGS. 1 and 2 is designed for a wideband lambda sensor and is used for determining the concentration of oxygen in the exhaust gas of an internal combustion engine or a combustion engine. The sensor element has a solid electrolyte body 11 which is made up of oxygen ion-conducting solid electrolyte layers 111 through 114 designed as ceramic films. Zirconium oxide (ZrO₂) fully or partially stabilized using yttrium, for example, is used as a solid electrolyte material. The integrated form of planar ceramic solid electrolyte body 11 is produced by laminating together the ceramic films printed with functional layers and subsequently sintering the laminated structure.

A first cavity 12 open to the outside is incorporated into topmost solid electrolyte layer 111 and is closed to the outside by a first cover 13. In the exemplary embodiment of FIGS. 1 and 2, first cover 13 is designed to be porous so that the exhaust gas flowing around the sensor element is able to penetrate into cavity 12.

A test gas chamber 14 and a reference gas channel 15 are formed in second solid electrolyte layer 112 lying under the first solid electrolyte layer. Test gas chamber 14 and reference gas channel 15 are covered by first solid electrolyte layer 111 and a third solid electrolyte layer 113, test gas chamber 14 being connected to first cavity 12 via a gas opening 16 incorporated into first solid electrolyte layer 111.

An external electrode 17 is situated on first solid electrolyte layer 111 on the bottom of first cavity 12. An internal electrode 18 is situated on first solid electrolyte layer 111 in test gas chamber 14. Both electrodes 17, 18 have the shape of circular rings of equal size and concentrically enclose gas opening 16. Both electrodes 17, 18 printed on solid electrolyte layer 111 together form a pump cell used to keep the oxygen concentration in test gas chamber 14 constant by pumping oxygen in and out.

In test gas chamber 14, a test or Nernst electrode 19 is situated on third solid electrolyte layer 113 opposite internal electrode 18. Nernst electrode 19 also has the shape of a circular ring and is printed on third solid electrolyte layer 113. A porous diffusion barrier 20 is placed upstream from internal electrode 18 and Nernst electrode 19 in the diffusion direction of the gas within test gas chamber 14. Porous diffusion barrier 20 forms a diffusion resistance with respect to the gas diffusing to electrodes 18, 19. A reference electrode 21 is situated in reference gas channel 15, to which a reference gas, e.g., air, is applied, reference electrode 21 lying under the extension area of first cavity 12. Reference gas channel 15 is separated from test gas chamber 14 by a remaining link in second solid electrolyte layer 112. Together with test or Nernst electrode 19, reference electrode 21 forms a Nernst or concentration cell which is used to measure the oxygen concentration.

In the same manner as in first solid electrolyte layer 111, a second cavity 22 is provided in fourth solid electrolyte layer 114 and is open to the outside and in this case is closed by a second cover 23. The bottom of second cavity 22 is coated with a coating 24 having low emissivity. Platinum is used as a coating material; however, other high-melting noble metals or their oxides having low emissivity coefficients, e.g., ruthenium oxide, may be used.

Located between third solid electrolyte layer 113 and fourth solid electrolyte layer 114 is an electrical resistance heater 25 which has a heating surface 251 extending in the area of electrodes 18, 19, 21 and two feeds 252 to heating surface 251. Heating surface 251 and feeds 252 are embedded in an insulation 26 of aluminum hydroxide (Al₂O₃), for example. Electrical resistance heater 25 is connected to a direct voltage, which is normally the system voltage of a vehicle and is used to heat the sensor element to an operating temperature of approximately 750° C. to 800° C. and to hold it at the operating temperature. The sensor element only operates optimally at this operating temperature and emits reliable measured values for the concentration of the gas component, oxygen in this case.

Due to their poor thermal conductivity, both cavities 12, 22 reduce the heat transfer from the internal area to the surface of the sensor element so that less heat energy is needed to hold the sensor element at the operating temperature. External electrode 17 produced from platinum in first cavity 12 and platinum coating 24 in second cavity 22 result in a boundary surface having a low emissivity coefficient and accordingly lower radiation losses. In addition, a platinum coating opposite external electrode 17 and platinum coating 24 could form a reflector which reflects the thermal radiation to the internal area of the sensor element. Overall, this has the result that the thermal losses of the sensor element are significantly reduced so that the cold sensor element is heated to its operating temperature more rapidly and that the sensor element is less strongly cooled by the test gas or exhaust gas flowing around it.

To achieve greater stability of the sensor element, both cavities 12, 22 may be filled with a porous material, e.g., a highly porous ceramic, having very similar thermal insulating properties. It is also possible to increase the mechanical stability of the sensor element by using braces in cavities 12 and 22 to brace first and second cover 13, 23, respectively, against the bottom of first and second cavities 12, 22, respectively.

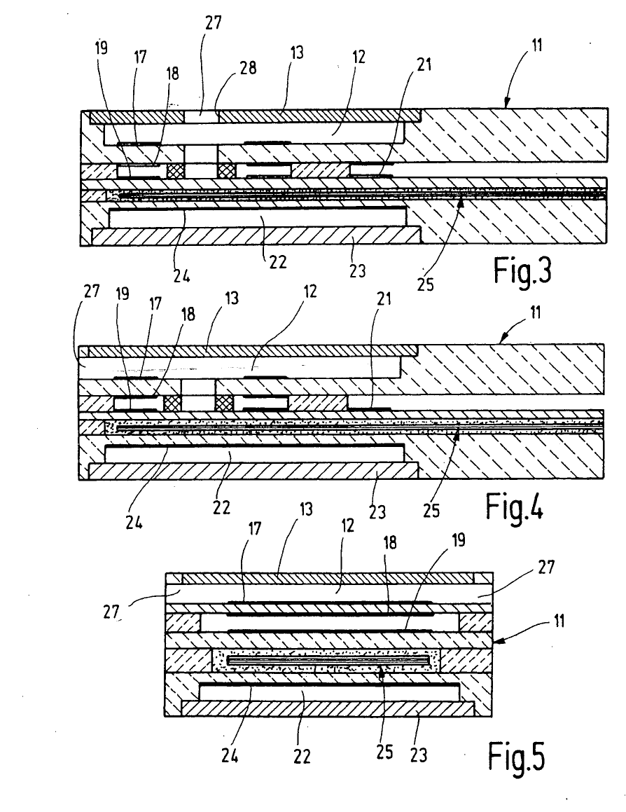

The exemplary embodiments of the sensor element shown in FIGS. 3 through 5 provide at least one gas access hole 27 opening into first cavity 12 via which the exhaust gas is able to enter cavity 12. In this case, it is no longer necessary for cover 13 to be gas-permeable. In FIG. 3, gas passage hole 27 is designed as a hole 28 penetrating cover 13. In FIGS. 4 and 5, gas passage hole 27 opening into first cavity 12 is incorporated in solid electrolyte body 11 and specifically in the face of solid electrolyte body 11 (FIG. 4) or in one of the long sides of solid electrolyte body 11 (FIG. 5). Moreover, the sensor elements shown in FIGS. 3 through 5 are consistent with the sensor element described according to FIGS. 1 and 2. For reasons of clarity, however, some reference numerals for identical components may not be shown in all figures.

The present invention is not limited to the described example of the sensor element for a wideband lambda sensor for determining the oxygen concentration in the exhaust gas of an internal combustion engine. The sensor element may also be designed for a λ=1 sensor or bistable sensor, and for a linear air-fuel sensor based on the limiting current principle. An example of the latter is found in published German patent document DE 100 54 828 or in published German patent document DE 101 14 186. It is also possible to detect other gas components in a gas mixture using the sensor element of the present invention, for example, nitrogen oxides in the exhaust gas of a combustion engine. A corresponding adaptation of the sensor element will also make it possible to determine another physical property of a test gas, e.g., the pressure in the test gas or in the exhaust gas of an internal combustion engine. Electrodes 17, 18 and 19 may also be of rectangular shape.

1-15. (canceled)

16. A sensor element for determining a concentration of a target gas component in a gas mixture, comprising:
a solid electrolyte body;
an external electrode exposed to the target gas component and situated in a first cavity formed in the solid electrolyte body;
an internal electrode situated in the solid electrolyte body; and
an electrical resistance heater embedded in an electrical insulation, wherein the electrical resistance heater and the electrical insulation are situated inside the solid electrolyte body, and wherein the electrical resistance heater has a meander-shaped heating surface.

17. The sensor element as recited in claim 16, wherein the external electrode is situated on the bottom of the first cavity facing away from the outside of the solid electrolyte body.

18. The sensor element as recited in claim 16, wherein the first cavity has an opening to the outside, and wherein the opening is covered by a first cover.

19. The sensor element as recited in claim 18, wherein the first cover is comprised of a gas-permeable, porous material and covers the first cavity.

20. The sensor element as recited in claim 18, wherein at least one gas passage hole leading to the first cavity is provided.

21. The sensor element as recited in claim 20, wherein the at least one gas passage hole is incorporated in one of the solid electrolyte body or in the first cover.

22. The sensor element as recited in claim 16, wherein the solid electrolyte body has a second cavity formed on an opposite side of the solid electrolyte body from the first cavity, and wherein the second cavity extends over the area of the heating surface.

23. The sensor element as recited in claim 22, wherein the second cavity is provided from the outer side of the solid electrolyte body facing away from the external electrode, and wherein the second cavity is covered by a second cover.

24. The sensor element as recited in claim 23, wherein the bottom surface of the second cavity opposite the second cover is provided with a coating having low emissivity.

25. The sensor element as recited in claim 24, wherein the coating is made of one of: a) high-melting noble metals; or b) oxides of high-melting noble metals.

26. The sensor element as recited in claim 22, wherein at least one of the first cavity and the second cavity is filled with a highly porous ceramic.

27. The sensor element as recited in claim 23, wherein braces are positioned in each of the first cavity and the second cavity to brace the first cover and the second cover against the bottom of the corresponding first cavity and the second cavity.

28. The sensor element as recited in claim 26, wherein the first cover and the second cover are made of a material having a higher thermal coefficient of expansion than a material of the solid electrolyte body.

29. The sensor element as recited in claim 22, wherein the sensor element is for a wideband lambda sensor, and wherein the internal and external electrodes form a pump cell, and wherein a reference gas channel and a test gas chamber are formed in the solid electrolyte body, the test gas chamber being connected to the first cavity via a diffusion barrier, and wherein the test gas chamber houses the internal electrode and one of a test electrode or a Nernst electrode opposite from the internal electrode, and wherein a reference electrode is situated within the reference gas channel.

30. The sensor element as recited in claim 29, wherein the first and second cavities extend over regions of the internal electrode, the external electrode, the one of the test electrode or the Nernst electrode, and the reference electrode.
